(19) United States
(12) Patent Application Publication
(10) Pub. No.: US 2026/0187292 A1
(43) Pub. Date: Jul. 2, 2026

(54) Integrated Physical and Cryptographic Security System for Serial Console, Serial Data Communication, and Ethernet Ports

(71) Applicant: Engage Communication, Inc., Aptos, CA (US)

(72) Inventors: Mark Thomas Doyle, Aptos, CA (US); Raul Gonzalez, Santa Maria, CA (US)

(21) Appl. No.: 19/433,415

(22) Filed: Dec. 26, 2025

Related U.S. Application Data
(60) Provisional application No. 63/738,950, filed on Dec. 26, 2024.

(51) Int. Cl. G06F 21/85; H01R 13/627; H04L 9/32

(52) U.S. Cl. CPC G06F 21/85; H01R 13/6272; H04L 9/3234

(57) ABSTRACT

An integrated physical and cryptographic security system for securing serial console ports, serial data communication ports, Ethernet ports, or other connector ports of electronic devices. A connector port locking apparatus has a main shell and a plug replicator nose for being received into the connector port. The plug replicator nose has opposed ramp surfaces with a portion sloped in a ventral-dorsal direction. Lugs project oppositely from a locking expansion member into engagement with the ramp surfaces, and a locking tooth projects dorsally from the locking expansion member. A motor and expansion bolt cooperate to propel the locking expansion member relative to the plug replicator nose, and the ramp surfaces induce extension and retraction of the locking expansion member dorsally into a locking position and ventrally into an unlocking position. Command signals received by wire or wirelessly actuate port locking and unlocking processes only through cryptographic multi-factor authentication.

### CROSS REFERENCE TO RELATED APPLICATION

This application claims priority to U.S. Provisional Application No. 63/738,950, filed Dec. 26, 2024, which is incorporated herein by reference.

### FIELD OF THE INVENTION

The present invention relates generally to computer security apparatuses and methods. More particularly, disclosed herein is an integrated physical and cryptographic security system for serial console, serial data communication, and Ethernet electronic connection ports wherein a plug replicator is configured to be selectively locked and unlocked in relation to a connection port of an electronic device under a secure, authenticated cryptographic protocol to prevent unauthorized access to the electronic device and to electronic networks to which the electronic device is connected.

### BACKGROUND OF THE INVENTION

Wired computer access grants bad actors the capability to penetrate a local network. Where security measures are insufficient to withstand an attack, local network penetration can be exploited to gain electronic access not merely to the individual computer but even to the wide area network infrastructure or application segment of a company to which the computer is connected. For instance, connecting to a network port normally enables the computer's internet protocol address to be dynamically obtained. This then allows the initiation of traffic and other activities within the network. Since Ethernet networks are based on a broadcasting medium and broadcasting protocols, computers and other devices connected to the same local network are in recurring communication. With a trusted server managing the addresses, a computer that has been overtaken by a bad actor is capable of accessing the correct internet protocol address instantaneously thus enabling that bad actor to begin operation within the network.

Thus, wired access to one computer can readily give the malicious actor access not only to the data and operation of the one machine but also largely unfettered access and control over an entire network. Physical exposure thus allows unauthorized individuals to access connection ports, to tamper with cables, and to alter device connections and configurations, and compromised Ethernet-connected devices, such as surveillance cameras and any other device, can be subject to unauthorized monitoring, interruption and interception of video, audio, and data feeds, and other tampering and malfeasance.

Meanwhile, nearly every computing device has at least one, and perhaps plural, exposed networking ports. Console ports, serial data communication interfaces, and Ethernet connections are fundamental to enabling reliable data exchange, system control, and monitoring across a wide range of critical applications. These exposed interfaces, which are widely used across multiple sectors, including industrial automation, supervisory control and data acquisition (SCADA), healthcare, transportation, telecommunication, aerospace, defense, and smart building systems, provide the very wired gateway needed by bad actors to gain access not only to the individual computing device but also to the computing network in general.

In an Ethernet network, for instance, networking ports are employed to provide data and power interconnections between computers, routers, servers, and other electronic devices. Twisted pair cables with an end connector at each end thereof are used to connect the electronic devices by plugging into openly accessible networking ports. Each Ethernet cable has eight copper wires that are twisted into pairs. The end connectors, commonly referred to as RJ-45 plug connectors, are matingly received into RJ-45 connector ports of the electronic devices to be connected. “RJ” stands for “Register Jack,” and “45” is the interface number assigned by the Federal Communications Commission. The RJ-45 connection enables not only data transmission but also Power-over-Ethernet (PoE). With that, power can be received through the same Ethernet cable that carries data. This PoE can eliminate the need for a separate power supply or outlet.

The RJ-45 plug is a male connector that is founded on a main body. The main body comprises a plastic shell with a rear opening for receiving the twisted-pair cable. The copper wires of the cable are connected to corresponding electrical contact pins retained by the plastic shell. A locking tab or latch extends at an acute angle from the main body to form an angled ramp, and one or more barbs project from the ramp for releasably locking the male plug connector within the female connector port.

The female jack forming the RJ-45 port is founded on a housing that defines a reception volume. The reception volume corresponds in size and shape to the male connector formed by the RJ-45 plug. The RJ-45 port has spring-loaded pins positioned to align with the contact pins of the RJ-45 plug. A retention clip or ledge of the RJ-45 port is configured to align in depth and lateral position with the barb or barbs of the locking tab.

Under this configuration, as the RJ-45 plug is slid into the port, the electrical contact pins of the RJ-45 plug slide into contact with the spring-loaded pins of the RJ-45 port and the locking tab is deflected toward the main body of the plug until the barb or barbs pass the retention clip or ledge of the RJ-45 port. The locking tab then springs upward to lock the plug in the port. The plug can be removed from the port by depressing the locking tab to disengage the barbs of the tab from the retention clip or ledge of the port.

Recognizing that exposed connector ports provide vulnerable entry points not only to the individual computer at hand but also to the network to which it is connected, multiple inventors have proposed mechanisms for locking RJ-45 Ethernet and other computer connector ports. Securing the computer port is, of course, at the core of such inventions. However, it will be recognized that there is the perhaps equally critical requirement of permitting authorized individuals to unlock the computer port when authorized access is appropriate.

With an awareness of the foregoing, the present inventors have appreciated that a port locking device must simultaneously achieve a plurality of potentially competing goals. Fundamentally, the port locking device must be effective in locking the port against unauthorized access. The port locking device will preferably be robust and durable in operation while remaining elegant in construction and performance. The port locking device must be difficult, ideally impossible, to remove by the unauthorized actor, but removal by the authorized person should be readily accomplished in an efficient and convenient manner. Still further, the mechanism by which the port locking device can be removed must not be easily replicated or counterfeited, even by persons with knowledge of the structure and function of the port locking device.

### SUMMARY OF THE INVENTION

The present invention is thus founded on the core object of providing a security system for effectively locking a connector port of a computing device to prevent unauthorized access to the connector port, to the computing device in which the port resides, and to the network to which the computing device belongs.

A more particular object of embodiments of the invention is to provide a connector port security system that is efficient in construction while remaining reliable and durable in operation.

Another particular object of embodiments of the invention is to provide a connector port security system that resists removal by unauthorized personnel, even those with knowledge of the operation of the port locking device.

A related object of practices of the invention is to provide a connector port security system wherein the mechanism for unlocking and removing the port locking device from a connector port resists being counterfeited or replicated by unauthorized persons.

A concomitant object of embodiments of the invention is to provide a connector port security system that enables unlocking and removal of a port locking device by authorized personnel in a relatively rapid and convenient manner.

The foregoing and further objects, advantages, and details of manifestations of the present invention will become obvious not only to one who reviews the present specification and drawings but also to those who have an opportunity to experience an embodiment of the integrated physical and cryptographic security system disclosed herein in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In carrying forth one or more objects of the invention, embodiments of the integrated physical and cryptographic security system for securing a connector port of an electronic device are founded on a connector port locking apparatus for securing serial console ports, serial data communication ports, Ethernet connections, including RJ-45, DB9, DB25, RS-232, ix industrial connectors, and other connector ports thereby physically preventing unauthorized access. The connector port locking apparatus has a main shell with an inner volume. A plug replicator nose is retained to project from the main shell and is configured for being received into the connector port of the electronic device. The plug replicator nose has a ramp surface sloped in what can be referred to as a dorsal-ventral direction. A locking expansion member is retained by the plug replicator nose with the locking expansion member and the ramp surface in relatively slidable engagement.

Under such constructions, a relative sliding of the locking expansion member and the ramp surface of the plug replicator nose in a first direction causes a dorsal extension of the locking expansion member to a locking position and a relative sliding of the locking expansion member and the ramp surface of the plug replicator nose in a second direction opposite the first direction causes a ventral retraction of the locking expansion member to an unlocking position. For avoidance of doubt, the terms dorsal and ventral are mere terms of direction to elucidate the present disclosure and are not intended to impose structural limitations on the disclosed invention.

In embodiments of the invention, the ramp surface is fixedly retained by the plug replicator nose while the locking expansion member is retained and configured for movement relative to the ramp surface and the plug replicator nose. However, except as expressly excluded by the claims, it is alternatively or additionally possible for the ramp surface to be movable.

The connector port locking apparatus can further include a motor retained within the main shell and a drive mechanism configured to be driven by the motor to propel the locking expansion member in the first direction into the locking position and in the second direction into the unlocking position. By way of non-limiting example, the motor can have a rotatable output shaft and the drive mechanism can take the form of a threaded expansion bolt. The expansion bolt can then be in threaded engagement with the locking expansion member. Under such embodiments, a rotation of the expansion bolt in a first rotational direction will propel the locking expansion member in the first direction and a rotation of the expansion bolt in a second rotational direction will propel the locking expansion member in the second direction.

Also according to embodiments of the invention, computer processing electronics, computer memory, computer software, and connectivity electronics can be retained by the main shell. Those connectivity electronics, computer processing electronics, computer memory, and computer software are configured to enable locking and unlocking command signals to be received by the connector port locking apparatus to actuate a port locking process in which the locking expansion member is moved in the first direction to the locking position and a port unlocking process in which the locking expansion member is moved in the second direction to the unlocking position.

As taught herein, the connectivity electronics, the computer processing electronics, the computer memory, and the computer software are configured to enable locking and unlocking command signals to be received by the connector port locking apparatus to actuate the port locking process and the port unlocking process, whether by wired connection, wirelessly, or otherwise, only through authenticated electronic connectivity. That authenticated electronic connectivity can, for instance, comprise cryptographic multi-factor authentication.

In certain practices, the connectivity electronics comprise an electronic connector port, such as a USB-c port, an Ethernet port, or any other electronic connector port, retained by the main shell in electronic communication with the computer processing electronics. The connectivity electronics can additionally or alternatively take the form of a wireless communication module, such as a Bluetooth module, retained by the main shell in electronic communication with the computer processing electronics. Additionally or alternatively, the connector port locking apparatus can connect to an external wireless communication module, such as by use of a USB-C or other connector port connected to an external USB-C WiFi module, a cellular modem, a Bluetooth module, or any other wireless module. Whether in a direct wired connection or by wireless communication, the connector port locking apparatus can provide user authentication and resultant control over the operation of the connector port locking apparatus, such as through a central management site or other authorized electronic control site or device.

Embodiments of the connector port locking apparatus can further include locking condition sensing technology configured to detect a position and locking condition of the expansion locking member in relation to the plug replicator nose. For instance, it is disclosed herein to provide a position sensing strip, such as a strip of metallic material, disposed along the ramp surface and an electrical contact material retained by the locking expansion member thereby to permit an electronic determination of the relative location of the locking expansion member along the ramp surface and thus the locking condition of the locking expansion member.

The ramp surface can be considered to comprise a first ramp surface, and the connector port locking apparatus can further include a second ramp surface. The first and second ramp surfaces can be disposed in opposition on the locking expansion member with an actuation volume disposed therebetween the first and second ramp surfaces and with the locking expansion member movably retained within the actuation volume. Where the ramp formations are disposed in opposition, the locking expansion member can have a main body and first and second lugs that project oppositely therefrom into slidable engagement with the first and second ramp surfaces.

In particular embodiments, the plug replicator nose replicates an electronic connector plug, such as an RJ-45 connector plug or any other style connector plug, in size and shape. So constructed, the plug replicator nose can have opposed first and second sidewalls with the first ramp surface formed by a track formation retained by the first sidewall and with the second ramp surface formed by a track formation retained by the second sidewall. Moreover, a plurality of electrical contacts can be retained by the plug replicator nose along the ventral side thereof to enable, among other things, Power-over-Ethernet (PoE).

The first and second track formations have matching shapes, each with a portion that is sloped in relation to a longitudinal direction of the plug replicator nose, such as in the dorsal direction from a distal portion of the plug replicator nose to a proximal portion of the plug replicator nose. Still further, each of the first and second track formations can further have a portion, such as the most proximal portion thereof, that is in alignment with the longitudinal direction not traveling dorsally or ventrally. When the lugs of the locking expansion member are received in that most proximal portion, ventral retraction of the locking expansion member is further prevented.

Embodiments of the locking expansion member have a main body and a locking tooth that projects from the main body. A dorsal extension of the locking expansion member to the locking position causes the locking tooth to project from the plug replicator nose to engage and lock in relation to the connector port, particularly the ledge thereof, and a ventral retraction of the locking expansion member to the unlocking position retracts the locking tooth relative to the plug replicator nose out of engagement with the ledge of the connector port.

In a further manifestation, the integrated physical and cryptographic security system for securing a connector port of an electronic device is again founded on a connector port locking apparatus with a main shell having an inner volume. A plug replicator nose is configured for being received into the connector port of the electronic device. The plug replicator nose is retained to project from the main shell in alignment with a longitudinal direction. The plug replicator nose has left and right sidewalls that communicate longitudinally, an actuation volume between the left and right sidewalls, a ventral side, and a dorsal side. A first ramp surface is retained by the left sidewall of the plug replicator nose, and a second ramp surface is retained by the right sidewall of the plug replicator nose. The first and second ramp surfaces are disposed in opposition and have matching shapes, each with a sloped portion that is sloped in a ventral-dorsal direction in relation to the longitudinal direction of the plug replicator nose. A locking expansion member is retained for longitudinal, dorsal, and ventral movement in relation to the actuation volume of the plug replicator nose. The locking expansion member has a main body, first and second lugs that project oppositely from the main body and into sliding engagement with the first and second ramp surfaces respectively, and a locking tooth that projects dorsally from the main body. As constructed, longitudinal movement of the locking expansion member in a first direction causes an extension of the locking expansion member in a dorsal direction to a locking position and a longitudinal movement of the locking expansion member in a second direction opposite the first direction causes a retraction of the locking expansion member in a ventral direction to an unlocking position.

A motor is again retained within the main shell, and a drive mechanism is configured to be driven by the motor to propel the locking expansion member in the first direction and the second direction. Comprising computer processing electronics, computer memory, computer software, and connectivity electronics retained by the main shell are configured to enable locking and unlocking command signals to be received by the connector port locking apparatus to actuate port locking and unlocking processes. Preferably, the locking and unlocking processes can be actuated, whether by wire, wirelessly, or by direct input to the connector port locking apparatus, only through authenticated electronic connectivity, such as cryptographic multi-factor authentication.

In a wired application, the connectivity electronics comprise an electronic connector port, such as a USB, Ethernet, or other port, retained by the main shell in electronic communication with the computer processing electronics. In wireless applications, the connectivity electronics comprise a wireless communication module, such as a Bluetooth module, retained by the main shell in electronic communication with the computer processing electronics. Additionally or alternatively, the connector port locking apparatus can connect to an external wireless communication module, such as by use of a USB-C or other connector port connected to an external USB-C WiFi module, a cellular modem, a Bluetooth module, or any other wireless module. Embodiments of the connector port locking apparatus can incorporate both wired and wireless connectivity electronics. Again, whether through a direct wired connection or by wireless communication, the connector port locking apparatus can provide user authentication and resultant authorized and authenticated control over the operation of the connector port locking apparatus, such as through a central management site or other authorized electronic control site or device.

Operation of the connector port locking apparatus can also rely at least in part on a sensed locking condition of the expansion locking member. For instance, where the connector port locking apparatus is already in a locked position, redundant actuation to the expansion locking member to a locking position can be prevented. Locking condition sensing technology is configured to detect a position and locking condition of the expansion locking member in relation to the plug replicator nose. As disclosed herein, the locking condition sensing technology could, by way of example, comprise an electrical contact strip communicating along the ramp surfaces in combination with an electrical contact retained by the expansion locking member, but other locking condition sensing technology could be employed, including visual sensors and any other effective sensing technology.

While other drive mechanisms are possible within the scope of the invention except as excluded by the claims, the motor can again have a rotatable output shaft while the drive mechanism comprises a threaded expansion bolt in threaded engagement with the locking expansion member. Thus, a rotation of the expansion bolt in a first rotational direction will propel the locking expansion member in the first direction, and a rotation of the expansion bolt in a second rotational direction will propel the locking expansion member in the second direction.

As disclosed herein, the first ramp surface can be formed by a track formation, such as a channel, a slot, or any other track formation, retained by the first sidewall, and the second ramp surface can be formed by a track formation retained by the second sidewall. The plug replicator nose can be considered to have a proximal portion retained by the main shell and a distal portion. The sloped portions of the first and second ramp surfaces are sloped in the dorsal direction from the distal portion to the proximal portion of the plug replicator nose. The first and second track formations have matching shapes with the sloped portion comprising a central portion thereof and with the sloped central portion contiguous with a proximal portion that is in alignment with the longitudinal direction thereby ensuring that the locking expansion member is locked against ventral movement.

Again as taught herein, the plug replicator nose can replicate an electronic connector plug, such as but not limited to an RJ-45 connector plug, in size and shape, and a plurality of electrical contacts can be retained by the plug replicator nose along the ventral side thereof. In such practices, the plurality of electrical contacts retained by the plug replicator nose can be configured to provide Power-over-Ethernet (PoE) to the connector port locking apparatus.

One will appreciate that the foregoing discussion broadly outlines certain goals and features of non-limiting embodiments of the invention to enable a better understanding of the detailed description that follows and to instill a better appreciation of the inventors'contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

The present invention will be described and explained with additional specificity and detail through reference to the accompanying drawings, wherein:

FIG. 1 is an upper perspective view of a connector port locking apparatus according to the present invention;

FIG. 2 is a lower perspective view of the connector port locking apparatus;

FIG. 3 is a view in right side elevation of the connector port locking apparatus;

FIG. 4 is a view in left side elevation of the connector port locking apparatus;

FIG. 5 is an exploded perspective view of the connector port locking apparatus;

FIG. 6 is a cross-sectional view of the connector port locking apparatus taken along the line 6-6 in FIG. 1;

FIG. 7 is a perspective view of the drive system for the connector port locking apparatus;

FIG. 8 is a top plan view of the drive system for the connector port locking apparatus;

FIG. 9 is a perspective view of the plug replicator nose with the expansion bolt communicating longitudinally therewithin;

FIG. 10 is a perspective view of the plug replicator nose;

FIG. 11 is a view in rear elevation of the plug replicator nose;

FIG. 12 is a cross-sectional view of the plug replicator nose taken along the line 12-12 in FIG. 11;

FIG. 13 is a cross-sectional view of the plug replicator nose taken along the line 13-13 in FIG. 11;

FIG. 14 is a perspective view of the expansion locking member, the expansion bolt, and the bolt holder of the connector port locking apparatus;

FIG. 15 is a view in side elevation of the expansion locking member, the expansion bolt, and the bolt holder of the connector port locking apparatus;

FIG. 16 is a perspective view of the expansion locking member;

FIG. 17 is a view in side elevation of the expansion locking member;

FIG. 18 is a view in rear elevation of the expansion locking member;

FIG. 19 is a cross-sectional view of the connector port locking apparatus with the plug replicator nose matingly received into a connector port and with the expansion locking member in an unlocked position;

FIG. 20 is a cross-sectional view of the connector port locking apparatus with the plug replicator nose matingly received into a connector port and with the expansion locking member in a locked position;

FIG. 21 is a schematic view of a connector port locking apparatus locked in position in a connector port of an electronic device and with a management computing device electronically connected to the connector port locking apparatus; and

FIG. 22 is a schematic view of first and second connector port locking apparatuses locked in position in connector port of first and second electronic devices with a physically and electronically secure electronic connection therebetween.

### DETAILED DESCRIPTION OF PREFERRED EMBODIMENTS

The present invention for an integrated physical and cryptographic security system could pursue widely varied embodiments. However, to ensure that one skilled in the art will be able to understand and, in appropriate cases, practice the invention, certain preferred embodiments of the broader invention revealed herein are described below and shown in the accompanying drawing figures. These embodiments are intended to be illustrative but are not intended to be limiting in any manner.

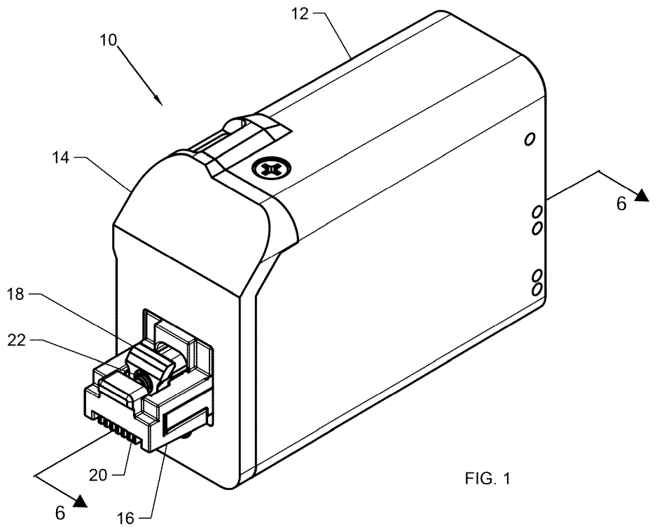

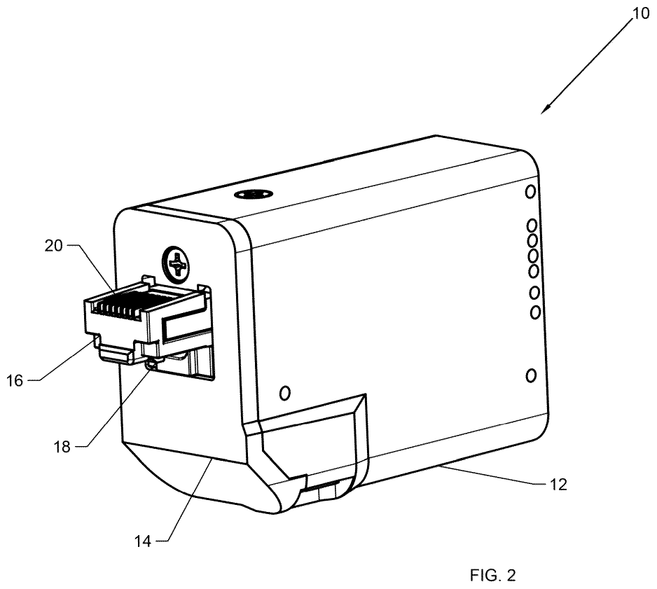

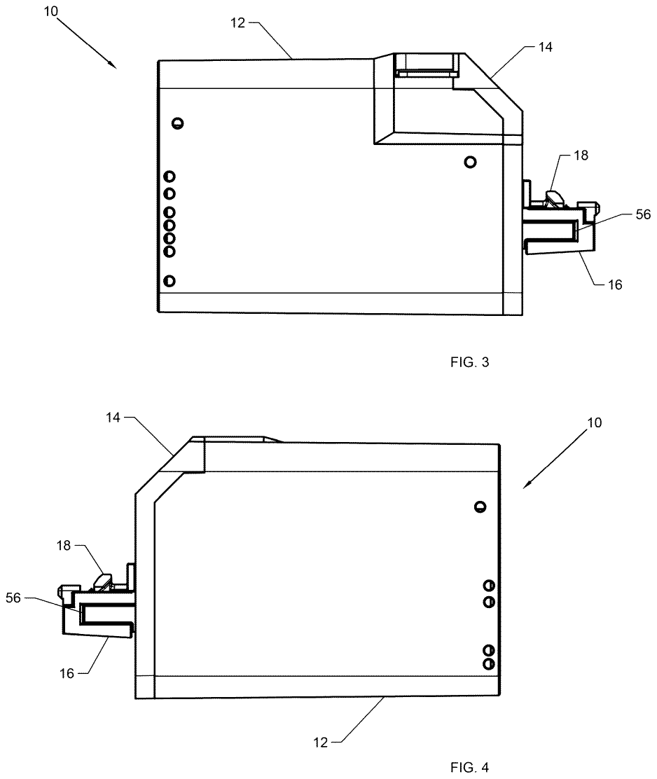

Turning more particularly to the drawings, an embodiment of a structure embodying the integrated physical and cryptographic security system disclosed herein is illustrated in FIGS. 1 through 6. There, the physical structure embodying the system, which may be alternatively referred to herein as a connector port locking apparatus, is indicated generally at 10. The connector port locking apparatus 10 has an inner volume defined by a main shell 12 in cooperation with an anterior shell wall 14. For ease of understanding but without imposing any structural or functional limitations on the invention, the connector port locking apparatus 10 can be considered to have an anterior end formed by the anterior shell wall 14 and a posterior end defined by a rear wall of the main shell 12 opposite the anterior shell wall 14. The main shell 12 in this embodiment has left and right sidewalls disposed in opposition, a top or dorsal wall, and a bottom or ventral wall in opposition to the dorsal wall. In this example, the anterior shell wall 14 has a generally planar portion disposed in parallel to the rear wall of the main shell 12 and a posteriorly angled upper portion such that the connector port locking apparatus 10 has a mitered portion joining the dorsal and anterior surfaces thereof. The connector port locking apparatus 10 can be considered to have a longitudinal direction communicating from the anterior to the posterior ends thereof, a lateral direction communicating from the left side wall to the right sidewall, and a dorsal-ventral direction communicating from the dorsal or top wall to the ventral or bottom wall.

A plug replicator nose 16 extends anteriorly from the anterior shell wall 14. The plug replicator nose 16 can, by way of example and not limitation, be integrally formed with the anterior shell wall 14, or it can be secured thereto or otherwise retained. The plug replicator nose 16 replicates in size and shape the plug corresponding to the connector port to be locked. As such, where the connector port locking apparatus 10 is configured for locking an RJ-45 port as in the present embodiment, the plug replicator nose 16 will have the exterior size and shape of an RJ-45 connector plug. The plug replicator nose 16 thus has a rectangular prism shape with a slight taper from the proximal to distal ends thereof. Recognizing that an RJ-45 plug typically has dimensions of 0.43 inches (11 mm) wide, 0.30 inches (7.6 mm) high, and 0.85 inches (21.6 mm) long, the plug replicator nose 16 will approximately match those dimensions.

Configuration of the plug replicator nose 16 in correspondence to the size and shape of an RJ-45 plug is illustrative. Except as expressly set forth in the claims, the invention is not limited to the locking of RJ-45 connector ports. Any other connector plug to engage any other connector port may be replicated, including by way of example and not limitation, USB ports, HDMI ports, serial console ports, other Ethernet ports, including RJ-11, RJ-14, RJ-45, RJ-48, DB-9, DB-25, RS-232, and ix industrial ports, and any other electronic connector port.

As used herein, the term “approximately” may be considered to mean within 10% of the stated value. The term “substantially” as used herein may broadly be considered to be any deviation that does not meaningfully affect function, performance, or intended use. Only where the foregoing is considered to be insufficiently clear, “substantially” with respect to a material property, such as “substantially rigid,” should be considered to be any deviation that is within 20% of the exact material property specified, such as by exhibiting a deflection under load within 20% of what a perfectly rigid body would allow. With respect to coverage or inclusion, “substantially” should be considered to be at least 90% of total coverage or inclusion, and “substantially” with regard to visual and structural properties should be considered to be within a deviation of 10% from the specified property, such as within 10% of perpendicular or within 10% of being perfectly flat.

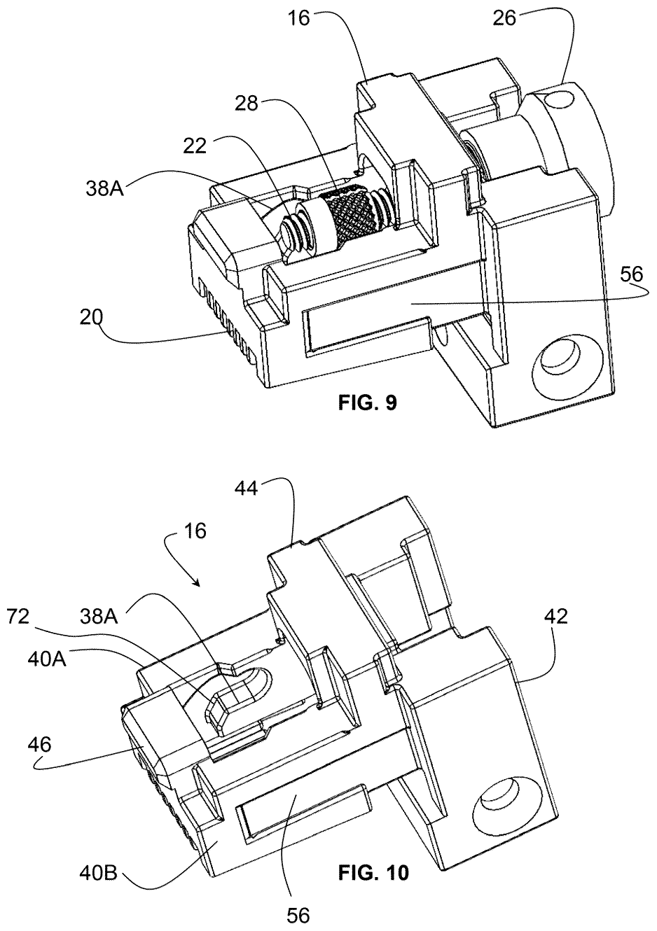

With further reference to FIGS. 10 through 13, the plug replicator nose 16 can be perceived to have opposed sidewalls 40A and 40B, a proximal wall 44, a distal wall 46, and a proximal framework 42. The proximal framework 42 is U-shaped whereby the central portion thereof is open, and the proximal framework 42 is fixed to the anterior shell wall 14, which is in turn fixed to the main shell 12, thereby fixing the plug replicator nose 16 in position. A plurality of electrical contacts or pins 20 are retained to communicate longitudinally along the ventral side of the plug replicator nose 16 to align with the electrical contacts of the connector port to be locked. Additionally, grounding tabs 56 to provide shield grounding for the connector port locking apparatus 10 are longitudinally disposed along the outwardly facing surfaces of the sidewalls 40A and 40B. The sidewalls 40A and 40B are disposed in parallel spaced relation to one another as are the proximal and distal walls 44 and 46. An actuation volume is thus defined between the sidewalls 40A and 40B, the proximal wall 44, and the distal wall 46.

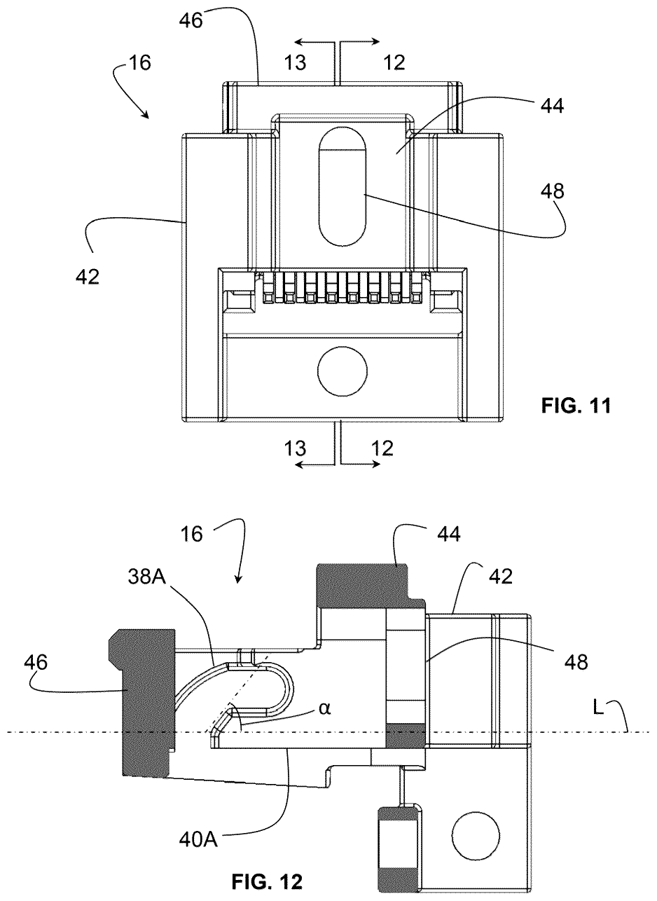

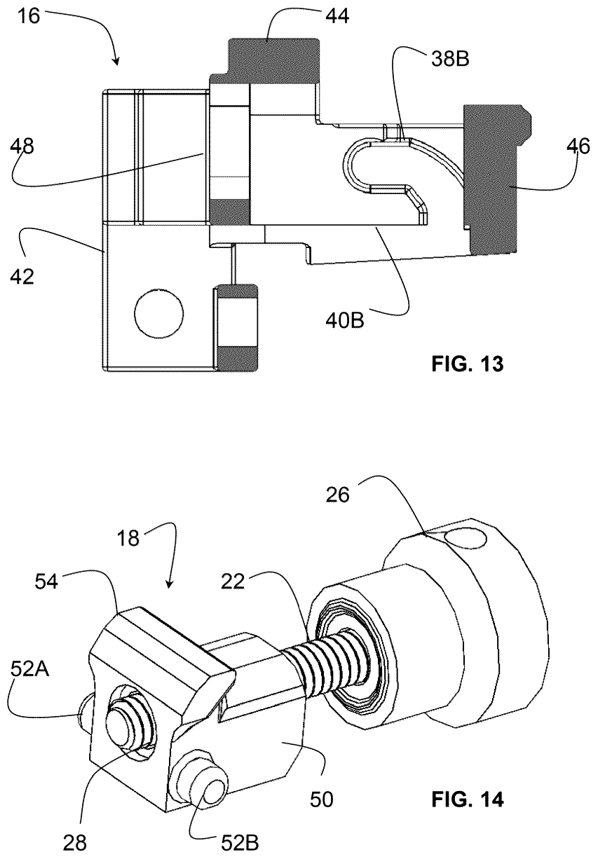

As best seen in FIGS. 11 and 12, the dorsal side of the actuation volume is open, and the proximal wall 44 of the plug replicator nose 16 has an expansion channel 48 formed therethrough. The expansion channel 48 is elongate in the dorsal-ventral direction. The opposed sidewalls 40A and 40B have matching opposed first and second track formations 38A and 38B. In this non-limiting embodiment, the track formations 38A and 38B are formed as channels that communicate within the inner face of the sidewalls 40A and 40B. However, the track formations 38A and 38B could alternatively comprise slots, rails, or other formations configured to provide sliding support and guidance. The track formations 38A and 38B are each bounded by a surface that has a ventral surface portion, which forms a lower surface portion where the plug replicator nose 16 is disposed as in FIGS. 12 and 13 with the open dorsal side of the actuation volume facing upwardly, a dorsal surface portion, which forms an upper surface portion in FIGS. 12 and 13, and a proximal surface portion spanning from the ventral to the dorsal surface portion. The plug replicator nose 16 is shaped to be received into a connector port with the open dorsal side of the actuation volume facing toward the ledge of the connector port that is positioned to align with and engage the barb or barbs of a locking tab of a connector plug according to the prior art.

As best seen in FIGS. 10, 12, and 13, each of the track formations 38A and 38B has a distal portion adjacent to the distal wall 46 of the plug replicator nose 16, a proximal portion closest to the proximal wall 44 of the plug replicator nose 16, and a central portion between the proximal and distal portions. In the present embodiment where the track formations 38A and 38B comprise channels formed in the interior faces of the sidewalls 40A and 40B, the distal portions of the channels comprising the track formations 38A and 38B are open to the ventral edge of the sidewalls 40A and 40B. The distal portions of the track formations 38A and 38B communicate substantially in the dorsal-ventral direction while the central portions of the track formations 38A and 38B, again comprising channels in this example, are sloped in the dorsal direction toward the open dorsal side of the actuation volume of the plug replicator nose 16 and away from the ventrally disposed electrical contacts 20. The central portions of the track formations 38A and 38B thus form ramps inclined in the dorsal direction toward the open dorsal side of the actuation volume of the plug replicator nose 16. Over the central portions of the track formations 38A and 38B, the dorsal surface portion is arcuate while the ventral surface portion is substantially straight apart from arcuate transitions to the distal and proximal portions of the track formations 38A and 38B. Over the central portions of the track formations 38A and 38B, the ventral surface portion is disposed distally to proximally at an incline angle α toward the open dorsal side of the actuation volume of the plug replicator nose 16 and away from the electrical contacts 20. The incline angle α can vary within the scope of the invention but may preferably be in the range of 20 to 70 degrees with respect to the longitudinal direction L. In the depicted embodiment, the incline angle of the sloped central portions of the track formations 38A and 38B is approximately 45 degrees. The proximal portions of the track formations 38A and 38B communicate in parallel and in alignment with the longitudinal direction L. As such, over the proximal portions of the track formations 38A and 38B, the dorsal and ventral surface portions defining the track formations 38A and 38B are sloped neither dorsally nor ventrally apart from the proximal surface portions spanning from the ventral to the dorsal surface portions, which are arcuate and have a radius of curvature sized to receive lugs 52A and 52B of the locking expansion member 18 as later shown and described in a close, concentric fit.

Where the connector port locking apparatus 10 is positioned as in FIG. 1, specifically with the electrical contacts or pins 20 facing downwardly and the dorsal side of the actuation volume facing upwardly to enable the plug replicator nose 16 to be matingly received into and to lock a connector port with the retention clip or ledge of the port to the top and the electrical contacts of the port to the bottom, the central portions of the track formations 38A and 38B can be considered to be sloped upwardly. However, the connector port locking apparatus 10 can engage connector ports in any orientation such that the central portions of the track formations 38A and 38B will be sloped downwardly where the plug replicator nose 16 is matingly received into a connector port with the retention clip or ledge of the port to the bottom. The central portions of the track formations 38A and 38B will be sloped toward the left where the plug replicator nose 16 is matingly received into a connector port with the retention clip or ledge to the left, and the central portions of the track formations 38A and 38B will be sloped toward the right when matingly received into a connector port with the retention clip or ledge to the right.

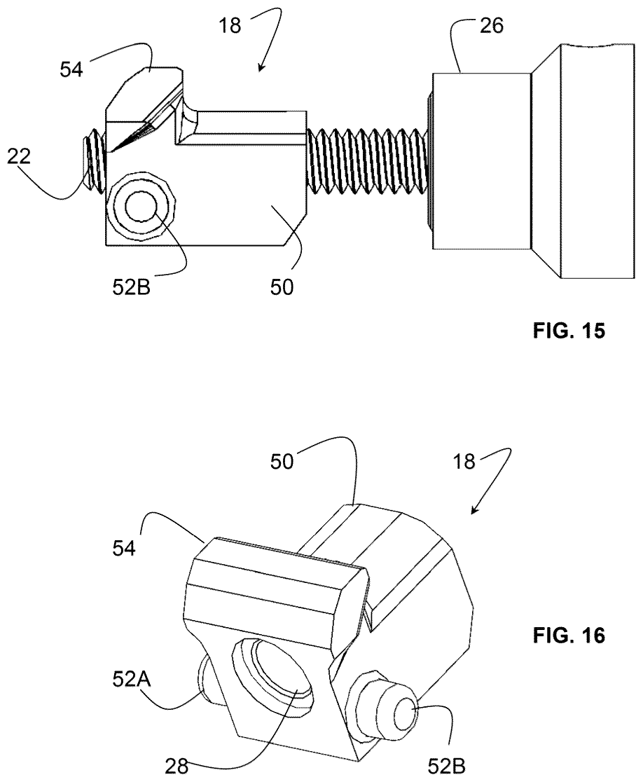

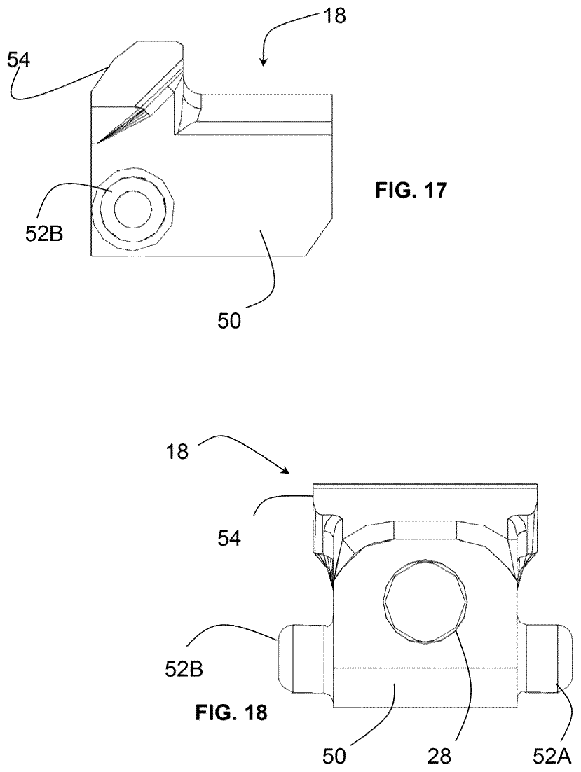

As FIGS. 1 through 8 illustrate, a locking expansion member 18 is disposed within the actuation volume defined between the sidewalls 40A and 40B, the proximal wall 44, and the distal wall 46 of the plug replicator nose 16. The expansion member 18 can be better perceived by reference to FIGS. 14 through 18 where the expansion member 18 is shown apart from the plug replicator nose 16. There, the expansion member 18 can be seen to be founded on a main body 50 that is generally block shaped with a flat bottom, flat left and right sides, proximal and distal ends, and an upper surface that is arched along the lateral direction. The main body 50 of the expansion member 18 is sized to be received within the actuation volume of the plug replicator nose 16 defined by the opposed sidewalls 40A and 40B and the opposed proximal and distal walls 44 and 46 yet freely movable within a range of motion in the longitudinal and dorsal-ventral directions.

A first lug 52A projects laterally from the right side of the main body 50 of the expansion member 18, and a second lug 52B projects laterally from the left side of the main body 50. The first and second lugs 52A and 52B are round in cross section and are disposed in alignment projecting from the main body 50 from adjacent to the corner junction between the distal end and the bottom of main body 50. The first and second lugs 52A and 52B are equal in size and shape. The lugs 52A and 52B extend from the main body 50 of the expansion member 18 in opposite directions to reach a distance greater than the distance by which the first and second track formations 38A and 38B are separated whereby the first and second lugs 52A and 52B are configured to ride and travel along the first and second track formations 38A and 38B. Where the first and second track formations 38A and 38B are formed as slots or as channels as in the illustrated embodiment, the first and second lugs 52A and 52B extend into the slots or channels comprising the first and second ramp formations 38A and 38B to travel therewithin.

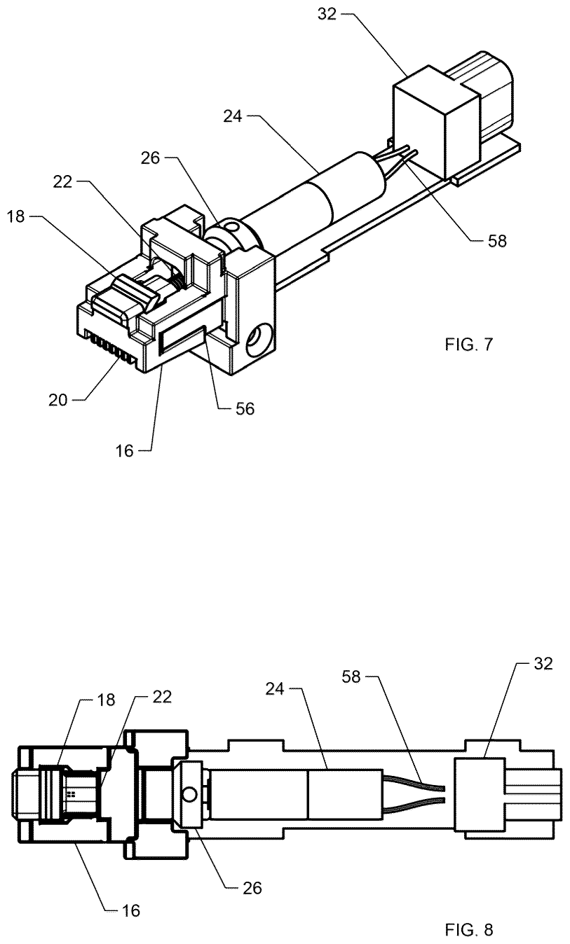

A locking tooth 54 projects in the dorsal direction from a distal portion of the main body 50 of the expansion member 18. The tooth 54 has a proximal surface that is orthogonally disposed to the main body and a rounded or faceted distal surface. The tooth 54 has laterally projecting portions that extend marginally beyond the main body 50 of the expansion member 18 in the left and right lateral directions. As best seen in FIGS. 7 through 10, the inwardly-facing surfaces of the sidewalls 40A and 40B dorsal to the first and second track formations 38A and 38B broaden in the distance between them through a faceted transition adjacent to the transition from the proximal portions to the central portions of the channels forming the track formations 38A and 38B. As shown in FIG. 8, the laterally projecting portions of the tooth 54 cause the tooth 54 to be broader laterally than the distance between the inwardly-facing surfaces of the sidewalls 40A and 40B over the proximal portions of the sidewalls 40A and 40B dorsal to the track formations 38A and 38B but narrower than the distance between the inwardly-facing surfaces of the sidewalls 40A and 40B over the central and distal portions of the sidewalls 40A and 40B dorsal to the ramp formations 38A and 38B. Under this configuration, the entire expansion member 18, including the tooth 54 projecting from the main body 50, can be moved in the ventral direction to be disposed within the actuation volume of the plug replicator nose 16 when the expansion member 18 is disposed in longitudinal alignment with at least the distal portions of the sidewalls 40A and 40B.

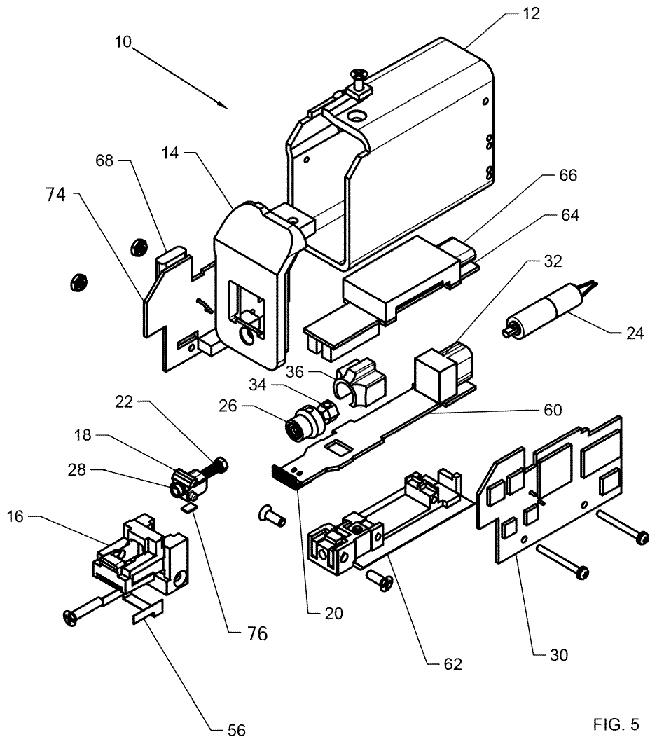

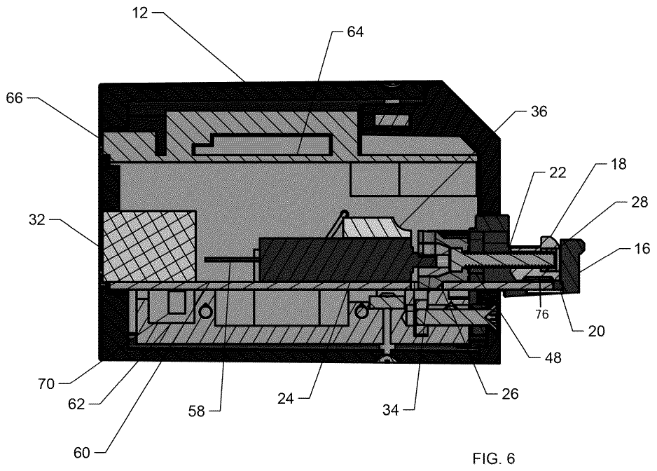

An expansion bolt 22, which is disposed to be rotatable about a longitudinal axis, is threadedly engaged with the expansion member 18. In the present embodiment, the expansion member 18 has a threaded insert 28 fixed therewithin in alignment with the longitudinal direction L, and the expansion bolt 22 is threaded and rotatably received by the threaded insert 28 thus to be threadedly engaged with the expansion member 18. The threaded insert 28 can be best perceived in the cross-sectional view of FIG. 6 and in FIG. 9 where the expansion member 18 is removed for clarity of illustration. It would, of course, be possible and within the scope of the threaded engagement contemplated herein to thread a bore hole through the expansion member 18. Under either such construction, rotation of the expansion bolt 22 in a first rotational direction, such as clockwise, will retract the expansion member 18 proximally away from the distal wall 46 and toward the proximal wall 44 of the plug replicator nose 16, and rotation of the expansion bolt 22 in a second rotational direction opposite the first, such as counter-clockwise, will extend the expansion member 18 distally away from the proximal wall 44 and toward the distal wall 46 of the plug replicator nose 16.

The expansion bolt 22 is selectively rotated by a motor 24. In the present embodiment, the motor 24 comprises a direct current electrical motor that incorporates a gearbox to achieve a desired rotary output speed. Still more particularly, the motor 24 can in certain embodiments comprise a cylindrical, coreless brushed direct current motor with a 700:1 plastic planetary gearbox. The motor 24 is connected to electrical power through wiring 58. The wiring 58 can, for instance, transmit electrical power to the motor 24 by a connection to a printed circuit board 60, which can in turn receive electrical power through the electrical contact pins 20 and thus through the connector port of a computing device when the plug replicator nose 16 of the connector port locking apparatus 10 is inserted into a connector port to be secured. Alternatively or additionally, electrical power can be provided by a power source, such as one or more batteries, retained within the connector port locking apparatus 10 and included, for instance, on circuit board 30.

Further electronic functionality and control is provided by one or more additional printed circuit boards 30, 60, 64, 74. The circuit boards 30, 60, 64, 74 retain computer processing electronics, computer memory, and other electronic features for retaining and processing dedicated computer software programming to operate the connector port locking apparatus 10 in securing a connector port and for releasing the connector port locking apparatus 10 from a connector port to enable access thereto.

The main body of the motor 24 is retained within the shell 12 by a motor bracket 36. The motor bracket 36 is fixed to the circuit board 60, which is in turn supported by a framework 62. The framework 62 is mounted to or integrally formed with the main shell 12. The motor 24 has a rotatable output shaft that is drivingly engaged with the expansion bolt 22, such as by having the rotatable output shaft received into or otherwise drivingly associated with the head of the expansion bolt 22. A stable, concentrically aligned relationship between the motor 24 and the expansion bolt 22 is ensured by a motor output support 34 that receives the rotatable output shaft of the motor 24 in combination with a bolt support 26 that rotatably retains the head of the expansion bolt 22. As best seen in FIG. 6, the motor output support 34 is matingly received into the bolt support 26 from a proximal direction thereby ensuring concentric alignment of the motor 24 and the expansion bolt 22 and smooth rotation of the expansion bolt 22. Together, the motor output support 34 and the bolt support 26 form a motor and bolt coupling. Additional framework and fastening features can be perceived by reference, for example, to FIG. 5.

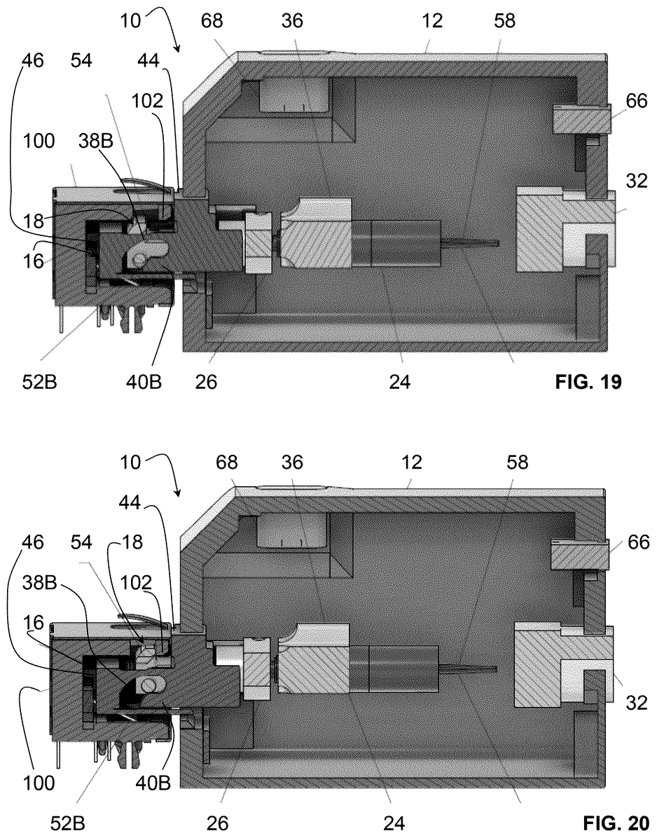

The connector port locking apparatus 10 itself incorporates one or more electronic connectors to enable electronic communication and control as taught herein. Except as the claims may be expressly limited, the electronic connector or connectors could comprise any now-existing or any future-developed electronic connector configuration. In the present example of the connector port locking apparatus 10, a USB-c connector port 66 is retained by a printed circuit board 64 for access from external to the main shell 12, specifically from the posterior face of the main shell 12. Additionally, an Ethernet connector port 32, which in this case comprises an ix industrial Ethernet connector port, is retained by printed circuit board 60, again for access from external to the posterior face of the main shell 12. Further, as FIGS. 19 and 20 show, a second USB-c connector port 68 can be incorporated and retained by one of the circuit boards 74 or otherwise. Through the printed circuit boards 30, 60, 64, 74, the connector ports 32, 66, and 68 are in electronic communication with the computer processing, computer memory, electrical power, and other electronics of the connector port locking apparatus 10. One or more of the connector ports 32, 66, and 68 can be configured to provide Power-over-Ethernet.

As FIG. 6 illustrates, embodiments of the connector port locking apparatus 10 can additionally incorporate a wireless communication module 70, such as but not limited to a Bluetooth connector, operative as connectivity electronics to enable remote communication to and from the connector port locking apparatus 10, such as for remote authentication to a centralized management server or other remote communication. Still further, it is within the scope of the invention for the connector port locking apparatus 10 to connect to an external wireless communication module, such as by use of a USB-C or other connector port 32, 66, or 68 connected to an external USB-C WiFi module, a cellular modem, a Bluetooth module, or any other wireless module. Whether through a direct wired connection or by wireless communication, the connector port locking apparatus 10 can provide user authentication and resultant authorized and authenticated control over the operation of the connector port locking apparatus 10, such as through a central management site or other authorized electronic control site or device.

One or more of the connector ports 32, 66, and 68 and the wireless communication module 70 or the external wireless communication module can be configured to operate as a virtual serial communication interface for secure data transfer while, at least with the wired connector ports 32, 66, and 68, simultaneously delivering power to and from the connector port locking apparatus 10. Where an Ethernet connection is established, otherwise unused cable wires and pin connections can be employed according to the invention to detect tampering with the Ethernet cable and connections. For instance, an original message comprising Ethernet frames with a pseudo-random pattern can be encrypted and transmitted over the send pair of wires, and these frames can be returned to be decrypted to produce a decrypted message over the receive pair of wires after being decrypted and re-encrypted, such as by using Public Key Infrastructure (PKI) with public and private keys or pre-shared keys. If the decrypted message does not match the original message, this may be interpreted by the system as an indication that there has been tampering with the cable or the pin connections. This tamper detection combined with computerized event logging and real-time alerts triggered by tamper detection ensure proactive threat detection and mitigation.

The connector port locking apparatus 10 also provides tamper detection operative to monitor the integrity of the physical and electronic connection between the connector port locking apparatus 10 and the connector port 100. More particularly, the connector port locking apparatus 10 has a tamper-detection circuit incorporated therein that employs a dynamic signal pattern to monitor the integrity of the physical and electronic connection between the connector port locking apparatus 10 and the connector port 100. The tamper-detection circuit can, for instance, monitor the integrity of the physical and electronic connection between printed circuit board 60, which can extend into the plug replicator nose 16 and which can have electrical contact with the electrical contact pins 20 retained thereby, with the electrical contacts of the connector port 100. The printed circuit board 60 of the connector port locking apparatus 10 retains a battery power source thereby providing a battery back-up to the connector port locking apparatus 10 even where external power is lost, such as through a termination of the connection to Power-over-Ethernet (PoE) through the connector port 100.

Through the dynamic signal pattern actuated by the electronic circuitry of the connector port locking apparatus 10, the connector port locking apparatus 10 is capable of detecting damage and tampering with the connection between the apparatus 10 and the connector port 100, including where the plug replicator nose 16 has been forcibly broken out of the connector port 100 or broken away from the main shell 12 of the connector port locking apparatus 10. One skilled in the art will be aware of numerous ways of carrying forth tamper detection operative to monitor the integrity of the physical and electronic connection between the connector port locking apparatus 10 and the connector port 100, including but not limited to the dynamic signal pattern referenced hereinabove. Each is within the scope of the present invention except as expressly excluded by the claims.

Under the foregoing construction of the connector port locking apparatus 10, a connector port 100 can be selectively locked against unauthorized access as is shown in the cross-sectional views of FIGS. 19 and 20. There, the plug replicator nose 16 is matingly received into the connector port 100 up to the proximal wall 44 of the plug replicator nose 16 whereby the sidewalls 40A and 40B, the distal wall 46, and the actuation volume of the plug replicator nose 16 retaining the expansion locking member 18 are disposed within the reception volume of the connector port 100. With the plug replicator nose 16 having a shape substantially matching the shape of a traditional connector plug and with the connector port 100 sized and shaped to receive such a plug with the locking tab of the plug facing the ledge 102 of the connector port 100 to lock the connector plug in place, the plug replicator nose 16 is inserted with the open dorsal side of the actuation volume, and thus the tooth 54 of the expansion locking member 18, facing toward the ledge 102 of the connector port 100. The orientation of the connector port locking apparatus 10 will thus depend on the orientation of the connector port 100 to be locked.

In FIG. 19, the connector port locking apparatus 10 is in an unlocked condition where the expansion locking member 18 is in a distal, ventrally retracted, unlocked position thereby permitting insertion and removal of the locking apparatus 10 from the connector port 100. In FIG. 20, the connector port locking apparatus 10 is in a locked condition where the expansion locking member 18 is in a proximal, dorsally extended, locked position thereby locking the plug replicator nose 16 and the connector port locking apparatus 10 in place relative to the connector port 100.

The expansion locking member 18 is moved between the distal, ventrally retracted, unlocked position of FIG. 19 and the proximal, dorsally extended, locked position of FIG. 20 by rotation of the expansion bolt 22, which is in turn selectively rotated by the motor 24. With a right-handed thread, a clockwise rotation of the expansion bolt 22 will draw the expansion locking member 18 proximally away from the distal wall 46 and toward the proximal wall 44 of the plug replicator nose 16, and a counter-clockwise rotation of the expansion bolt 22 will propel the expansion locking member 18 distally away from the proximal wall 44 and toward the distal wall 46 of the plug replicator nose 16.

With the lugs 52A and 52B slidably received in the track formations 38A and 38B, selective rotation of the expansion bolt 22 produces a longitudinal retraction of the expansion locking member 18 from a distal position, such as a position as shown in FIG. 19, to a retracted position, such as a position as shown in FIG. 20. This movement establishes a port locking process as the lugs 52A and 52B then travel along the ramped central portions of the track formations 38A and 38B of the plug replicator nose 16 thereby moving move the lugs 52A and 52B and thus the expansion locking member 18 and the tooth 54 thereof simultaneously in the proximal and dorsal directions. As the expansion locking member 18 is moved in the proximal and dorsal directions, the expansion bolt 22 is advantageously free to move in the dorsal direction within the expansion channel 48 in the proximal wall 44 of the plug replicator nose 16 as can be further understood with reference to FIGS. 6 and 11. The tooth 54 of the expansion locking member 18 is thus caused to extend through the open dorsal side of the actuation volume and into a dorsally extended, locking engagement with the ledge 102 of the connector port 100. Where the expansion locking member 18 is longitudinally retracted sufficiently to place the lugs 52A and 52B within the proximal portions of the track formations 38A and 38B, which communicate in parallel with the longitudinal L direction of the plug replicator nose 16, dorsal and ventral movement of the expansion locking member 18 is prevented. Removal of the connector port locking apparatus 10 is prevented by the engagement of the tooth 54 with the ledge 102 of the connector port 100. The connector port locking apparatus 10 is locked in place, and the connector port 100 is protected from unauthorized access.

Conversely, in a port unlocking process, an opposite rotation of the expansion bolt 22 produces a longitudinal extension of the expansion locking member 18, such as from the proximal position of FIG. 20 to the extended position of FIG. 19. This causes the lugs 52A and 52B to travel along the ramped central portions of the track formations 38A and 38B of the plug replicator nose 16 to move the lugs 52A and 52B and thus the expansion locking member 18 and the tooth 54 thereof simultaneously in the distal and ventral directions. As the expansion locking member 18 is moved in the distal and ventral directions, the expansion bolt 22 is free to move in the ventral direction within the expansion channel 48 in the proximal wall 44 of the plug replicator nose 16. The tooth 54 of the expansion locking member 18 is thus caused to retract in the ventral direction, into the actuation volume, and out of engagement with the ledge 102 of the connector port 100. The connector port locking apparatus 10 can thus be non-destructively removed from the connector port 100 to render the port 100 accessible for normal usage. Of course, the ramped central portions of the track formations 38A and 38B could be oppositely disposed, which would cause longitudinal retraction of the expansion locking member 18 to produce its ventral retraction and longitudinal extension of the expansion locking member 18 to produce its dorsal extension.

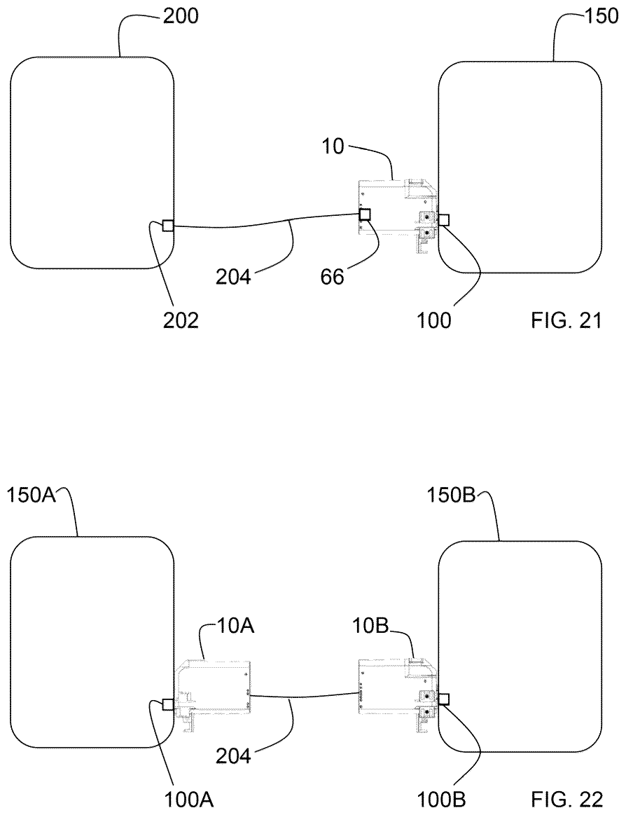

Preferred practices of the connector port locking apparatus 10 incorporate tamper-reactive electronics within the computer memory and programming of the circuit boards 60 and 64. Without limiting the foregoing, the connector port locking apparatus 10 in preferred embodiments utilizes cryptographic multi-factor authentication to restrict electronic access and control over the apparatus 10 and the port locking and unlocking processes. One of the multiple possible manifestations of the electronic access and control over the connector port locking apparatus 10 is illustrated in FIG. 21. There, a connector port locking apparatus 10 is lockingly engaged with a connector port 100 of a computing or other electronic device 150 to be protected. The electronic device 150 can be any electronic device with an electronic connector port 100. What may be referred to as a management computing device 200 is in electronic connection and communication with the connector port locking apparatus 10 through an electronic connection 204, which could be a tamper-resistant cable, a wireless connection, or any other electronic connection 204.

Hardware and software for electronic connection and communication, whether wired, wireless, or some combination thereof may be broadly referred to herein as electronic connectivity or connectivity electronics. Wired, unless otherwise specified, should be understood to include a direct plug connection, such as of a connector plug inserted into a connector port. In the illustrated example, a connector port 202, such as a USB port, of the management computing device 200 is electronically connected to the connector port locking apparatus 10, such as through the USB port 66 of the apparatus 10, by a tamper-reactive cable 204, but it will again be understood that a wireless connection, such as but not limited to by a Bluetooth connection, could be additionally or alternatively employed. The electronic connection 204 and the internet protocol and other electronic communications can be encrypted, such as through Advanced Encryption Standard (AES) or any other encryption standard.

According to practices of the invention, Ethernet and other cable tamper detection mechanisms monitor for disconnection, cutting, or other unauthorized physical access to cables, such as the tamper-reactive cable 204. Alerts are triggered and logged by electronic detection and by computer processing by the system when tampering is detected. For instance, sensors are embedded in the connector port locking apparatus 10, such as in printed circuit boards 30, 60, or 64, and electronic connection cables 204, to detect physical tampering and disconnection attempts and to trigger real-time alerts. For instance, alerts can be logged locally and reported to centralized monitoring systems for proactive security management. Operation of the connector port locking apparatus 10 can employ multi-factor authentication (MFA) integrating cryptographic methods, such as but not limited to digital signatures, identification numbers, hardware tokens, and biometrics to verify user identity and authorization. In certain practices of the invention, centralized authentication, authorization, and accounting security paradigms enable dynamic user management and real-time access control. In other practices of the invention, a standalone mode enables local cryptographic authentication without external servers, such as for remote or offline locations.

With an electronic connection 204 established between the management computing device 200 and the connector port locking apparatus 10, the locking and unlocking processes of the apparatus 10 can be selectively initiated. The initiation and execution of locking and unlocking command signals initiating locking and unlocking movement of the expansion locking member 18 are restricted to secure, authenticated electronic connectivity, in particular through cryptographic multi-factor authentication between any external source, such as but not limited to a management computing device 200, and the connector port locking apparatus 10. Locking and unlocking command signals can be imparted to the connector port locking apparatus 10 only through authenticated electronic connectivity. In present practices of the invention, a terminal emulator operating on the management computing device 200 utilizes a secure shell protocol (SSH) to ensure that the management computing device 200 is connected to the connector port locking apparatus 10 with electronic security.

The port security provided by the connector port locking apparatus 10 is thus configured to work with an access monitoring system operative, for instance, on the management computing device 200 that is external to the apparatus 10 to provide reliable cyber security logging, monitoring, alerting, and compliance functionality. Authentication remote to the connector port locking apparatus 10, whether wired or wireless, also enables systems according to the present invention to ensure that the correct connector port 100 is being accessed.

As FIG. 22 illustrates, it is also within the scope of the invention for plural connector port locking apparatuses, such as those indicated at 10A and 10B, to be employed in combination to establish secured and protected interconnections between critical computer infrastructure, such as but not limited to critical Ethernet connections between first and second electronic devices 150A and 150B. The electronic devices 150A and 150 can be of any type. In one illustrative but non-limiting example, the first electronic device 150A could be a supervisory control and data acquisition (SCADA) device, and the second electronic device 150B could be a programmable logic controller (PLC). The connector port locking apparatuses 10A and 10B can be locked in relation to the respective connector ports 100A and 100B, and a physically and electronically secure electronic connection 204 is established between the connector port locking apparatuses 10A and 10B and, through them, the electronic devices 150A and 150B to which they are locked. That physically and electronically secure electronic connection 204 could be a tamper-reactive cable 204 fixedly wired into the connector port locking apparatuses 10A and 10B, or the connection 204 could be additionally or alternatively established by a secure wireless connection between the connector port locking apparatuses 10A and 10B, such as through Bluetooth modules 70 or an external wireless module as previously described. Electronic communication between the connector port locking apparatuses 10A and 10B and thus between the devices 150A and 150B is encrypted and authenticated, such as through the Advanced Encryption Standard (AES) or any other encryption standard and public key infrastructure (PKI).

For avoidance of doubt, while secure, authenticated control over the locking and unlocking processes of the connector port locking apparatus 10 has been shown and described as being exerted by tamper-reactive wire or wirelessly under an encrypted, authenticated protocol, it is within the scope of the invention for secure control input to be applied directly to the connector port locking apparatus 10. For instance, the connector port locking apparatus 10 could incorporate a user interface, such as a touch screen, a key pad, both a touch screen and a key pad, or another data entry user interface. Except as expressly excluded, such integrated control is within the scope of the claims.

Whether by wire as by connection to one of the USB-c ports 66 or 68 or the Ethernet port 32, wirelessly as by Bluetooth, or potentially by integration of authenticated control into the connector port locking device 10 itself, the integrated physical and cryptographic security system provides secure, authenticated control over the connector port locking apparatus 10 to initiate the locking and unlocking processes of the connector port locking apparatus 10 to selectively lock and unlock a connector port 100 of an electronic device 150. By an encrypted locking command signal, the connector port locking apparatus 10 can be actuated in a port locking process from an unlocked condition where the expansion locking member 18 and the tooth 54 thereof are ventrally retracted within the plug replicator nose 16 as in FIG. 19 to a locked condition as in FIG. 20 where the expansion locking member 18 is moved in the proximal and dorsal directions to bring the tooth 54 into a dorsally extended position in locking engagement with the ledge 102 of the connector port 100. More particularly, with Power-over-Ethernet (PoE) by contact of the pins 20 of the connector port locking apparatus 10 or by electrical power provided by an integrated power source, the locking command signal received by the connector port locking device 10 is employed by the circuitry of the printed circuit boards 60 and 64 to induce operation of the motor 24 to rotate the expansion bolt 22 in a first rotational direction to produce a longitudinal retraction of the expansion locking member 18 from a distal position to a longitudinally retracted position. That longitudinal retraction causes the lugs 52A and 52B to travel along the ramped central portions of the track formations 38A and 38B of the plug replicator nose 16 to move the expansion locking member 18 simultaneously in the proximal and dorsal directions. The tooth 54 of the expansion locking member 18 thus is driven proximally and dorsally to extend from the plug replicator nose 16 into a locked position in locking engagement with the ridge 102 of the connector port 100 locking the connector port locking apparatus 10 in place and protecting the connector port 100 against unauthorized access.

When access to the connector port 100 is desired, the port unlocking process can be actuated by an unlocking command signal imparted by wired connection, wireless connection, or authenticated control integrated into the connector port locking apparatus 10. The unlocking command signal triggers an opposite rotation of the expansion bolt 22 to propel the expansion locking member 18 distally in the longitudinal direction thereby causing the lugs 52A and 52B of the expansion locking member 18 to slide along the ramped central portions of the track formations 38A and 38B to move the expansion locking member 18 and the tooth 54 thereof distally and ventrally simultaneously. The tooth 54 of the expansion locking member 18 is thereby retracted in the ventral direction into the actuation volume to an unlocked position. The tooth 54 moves out of engagement with the ledge 102 of the connector port 100 thereby permitting removal of the connector port locking apparatus 10 from the connector port 100 to permit access to the connector port 100.

Embodiments of the connector port locking apparatus 10 incorporate locking condition sensing technology configured to detect whether the expansion locking member 18 is in a locked position, an unlocked position, or perhaps somewhere in between and thus whether the connector port locking apparatus 10 is in a locked condition, an unlocked condition, or perhaps in between the locked and unlocked conditions. The locking condition sensing technology could pursue numerous forms, each within the scope of the present invention.

In one such embodiment as in FIG. 5, a proximity sensor 76 is retained by circuit board 60 in electrical communication therewith to reside ventral to the expansion locking member 18. The proximity sensor can thus detect the position of the expansion locking member 18 to determine, for instance, that the expansion locking member 18 is dorsally extended to establish the locking condition of the connector port locking apparatus 10 or whether the expansion locking member 18 is ventrally retracted to establish the unlocking condition of the connector port locking apparatus 10.

In an alternative embodiment as in FIG. 10, a position sensing strip 72, such as a strip of metallic material, is disposed along the ventral surface, the dorsal surface, or the dorsal and ventral surfaces of either or both track formations 38A and 38B, and at least a portion of the lug or lugs 52A and 52B is metallic, such as with an electrical contact surface, for contacting the position sensing strip or strips 72. The position sensing strip 72 is in electrical communication with a circuit or circuits of one or more of the printed circuit boards 60 and 64. Under such constructions, the system can detect the position of the expansion locking member 18 along the track formations 38A and 38B and thus the locking condition of the connector port locking apparatus 10 with it being known, for instance, that the connector port locking apparatus 10 is in an unlocked condition when the expansion locking member 18 is in a distal position along the track formations 38A and 38B and that the connector port locking apparatus 10 is in a locked condition when the expansion locking member 18 is in a proximal position along the track formations 38A and 38B.

With certain details and embodiments of the present invention for an integrated physical and cryptographic security system disclosed, it will be appreciated by one skilled in the art that numerous changes and additions could be made thereto without deviating from the spirit or scope of the present invention. This is particularly true when one bears in mind that the presented preferred embodiments merely exemplify the broader invention revealed herein. Accordingly, it will be clear that those with major features in mind could craft embodiments that incorporate those major features while not incorporating all of the features included in the preferred embodiments.

Therefore, the following patent claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

1. An integrated physical and cryptographic security system for securing a connector port of an electronic device, the system comprising:
a connector port locking apparatus comprising:
a main shell with an inner volume;
a plug replicator nose configured for being received into the connector port of the electronic device, wherein the plug replicator nose is retained to project from the main shell, wherein the plug replicator nose has a ventral side, a dorsal side, and a dorsal-ventral direction, and wherein the plug replicator nose has a ramp surface with a portion sloped in the dorsal-ventral direction of the plug replicator nose;
a locking expansion member retained by the plug replicator nose, wherein the locking expansion member and the ramp surface of the plug replicator nose are in relatively slidable engagement;
whereby a relative sliding of the locking expansion member and the ramp surface of the plug replicator nose in a first direction causes a dorsal extension of the locking expansion member to a locking position and whereby a relative sliding of the locking expansion member and the ramp surface of the plug replicator nose in a second direction opposite the first direction causes a ventral retraction of the locking expansion member to an unlocking position.

2. The system for securing a connector port of claim 1, wherein the ramp surface is fixedly retained by the plug replicator nose and wherein the locking expansion member is retained and configured for movement relative to the ramp surface and the plug replicator nose.

3. The system for securing a connector port of claim 1, further comprising a motor retained within the main shell and a drive mechanism configured to be driven by the motor to propel the locking expansion member in the first direction into the locking position and in the second direction into the unlocking position.

4. The system for securing a connector port of claim 3, wherein the motor has a rotatable output shaft and wherein the drive mechanism comprises a threaded expansion bolt wherein the expansion bolt is in threaded engagement with the locking expansion member whereby a rotation of the expansion bolt in a first rotational direction will propel the locking expansion member in the first direction and a rotation of the expansion bolt in a second rotational direction will propel the locking expansion member in the second direction.

5. The system for securing a connector port of claim 3, further comprising computer processing electronics, computer memory, computer software, and connectivity electronics retained by the main shell, wherein the connectivity electronics, the computer processing electronics, the computer memory, and the computer software are configured to enable locking and unlocking command signals to be received by the connector port locking apparatus to actuate a port locking process wherein the locking expansion member is moved in the first direction to the locking position and a port unlocking process wherein the locking expansion member is moved in the second direction to the unlocking position.

6. The system for securing a connector port of claim 5, wherein the connectivity electronics, the computer processing electronics, the computer memory, and the computer software are configured to enable locking and unlocking command signals to be received by the connector port locking apparatus to actuate the port locking process and the port unlocking process only through authenticated electronic connectivity.

7. The system for securing a connector port of claim 6, wherein the authenticated electronic connectivity comprises cryptographic multi-factor authentication.

8. The system for securing a connector port of claim 6, wherein the connectivity electronics comprise an electronic connector port retained by the main shell in electronic communication with the computer processing electronics.

9. The system for securing a connector port of claim 6, wherein the connectivity electronics comprise a wireless communication module retained by the main shell in electronic communication with the computer processing electronics.

10. The system for securing a connector port of claim 1, further comprising locking condition sensing technology configured to detect a position and locking condition of the locking expansion member (18) in relation to the plug replicator nose.

11. The system for securing a connector port of claim 1, wherein the ramp surface comprises a first ramp surface and further comprising a second ramp surface, wherein the first and second ramp surfaces are disposed in opposition with an actuation volume disposed between the first and second ramp surfaces, and wherein the locking expansion member is movably retained within the actuation volume.

12. The system for securing a connector port of claim 11, wherein the locking expansion member has a main body and first and second lugs that project oppositely from the main body and into slidable engagement with the first and second ramp surfaces.

13. The system for securing a connector port of claim 12, wherein the plug replicator nose has opposed first and second sidewalls, wherein the first ramp surface is formed by a track formation retained by the first sidewall, and wherein the second ramp surface is formed by a track formation retained by the second sidewall.

14. The system for securing a connector port of claim 13, wherein the first and second track formations have matching shapes, wherein each of the first and second track formations has a portion that is sloped in the dorsal-ventral direction of the plug replicator nose in relation to a longitudinal direction of the plug replicator nose.

15. The system for securing a connector port of claim 14, wherein each of the first and second track formations further has a portion that is in alignment with the longitudinal direction.

16. The system for securing a connector port of claim 1, wherein the locking expansion member has a main body and a locking tooth that projects from the main body wherein a dorsal extension of the locking expansion member to the locking position causes the locking tooth to project from the plug replicator nose and wherein a ventral retraction of the locking expansion member to the unlocking position retracts the locking tooth relative to the plug replicator nose.

17. The system for securing a connector port of claim 1, wherein the plug replicator nose replicates an electronic connector plug in size and shape; wherein the plug replicator nose has left and right sidewalls, and an actuation volume between the left and right sidewalls; and wherein the locking expansion member is movably retained within the actuation volume.

18. The system for securing a connector port of claim 17, further comprising a plurality of electrical contacts retained by the plug replicator nose along the ventral side of the plug replicator nose.

19. An integrated physical and cryptographic security system for securing a connector port of an electronic device, the system comprising:
a connector port locking apparatus comprising:
a main shell with an inner volume;
a plug replicator nose configured for being received into the connector port of the electronic device, wherein the plug replicator nose is retained to project from the main shell, wherein the plug replicator nose has left and right sidewalls that communicate longitudinally, an actuation volume between the left and right sidewalls, a ventral side, and a dorsal side;
a first ramp surface retained by the left sidewall of the plug replicator nose and a second ramp surface retained by the right sidewall of the plug replicator nose, wherein the first and second ramp surfaces are disposed in opposition, wherein the first and second ramp surfaces have matching shapes, wherein each of the first and second ramp surfaces has a sloped portion that is sloped in a ventral-dorsal direction in relation to a longitudinal direction of the plug replicator nose;
a locking expansion member retained for longitudinal, dorsal, and ventral movement in relation to the actuation volume of the plug replicator nose, wherein the locking expansion member has a main body, first and second lugs that project oppositely from the main body and into sliding engagement with the first and second ramp surfaces respectively, and a locking tooth that projects dorsally from the main body;
whereby a longitudinal movement of the locking expansion member in a first direction causes an extension of the locking expansion member in a dorsal direction to a locking position and whereby a longitudinal movement of the locking expansion member in a second direction opposite the first direction causes a retraction of the locking expansion member in a ventral direction to an unlocking position.

20. The system for securing a connector port of claim 19, further comprising a motor retained within the main shell, a drive mechanism configured to be driven by the motor to propel the locking expansion member in the first direction and the second direction.

21. The system for securing a connector port of claim 20, further comprising computer processing electronics, computer memory, computer software, and connectivity electronics retained by the main shell, wherein the connectivity electronics, the computer processing electronics, the computer memory, and the computer software are configured to enable locking and unlocking command signals to be received by the connector port locking apparatus to actuate a port locking process wherein the locking expansion member is moved in the first direction to the locking position and a port unlocking process wherein the locking expansion member is moved in the second direction to the unlocking position.

22. The system for securing a connector port of claim 21, wherein the connectivity electronics, the computer processing electronics, the computer memory, and the computer software are configured to enable locking and unlocking command signals to be received by the connector port locking apparatus to actuate the port locking process and the port unlocking process only through authenticated electronic connectivity.

23. The system for securing a connector port of claim 22, wherein the authenticated electronic connectivity comprises cryptographic multi-factor authentication.

24. The system for securing a connector port of claim 22, wherein the connectivity electronics comprise an electronic connector port retained by the main shell in electronic communication with the computer processing electronics.

25. The system for securing a connector port of claim 22, wherein the connectivity electronics comprise a wireless communication module retained by the main shell in electronic communication with the computer processing electronics.

26. The system for securing a connector port of claim 21, further comprising locking condition sensing technology configured to detect a position and locking condition of the locking expansion member in relation to the plug replicator nose.

27. The system for securing a connector port of claim 20, wherein the motor has a rotatable output shaft and wherein the drive mechanism comprises a threaded expansion bolt wherein the expansion bolt is in threaded engagement with the locking expansion member whereby a rotation of the expansion bolt in a first rotational direction will propel the locking expansion member in the first direction and a rotation of the expansion bolt in a second rotational direction will propel the locking expansion member in the second direction.

28. The system for securing a connector port of claim 19, wherein the first ramp surface is formed by a track formation retained by the first sidewall, wherein the second ramp surface is formed by a track formation retained by the second sidewall, and wherein the first and second track formations have matching shapes.

29. The system for securing a connector port of claim 28, wherein each of the first and second track formations further has a portion that is in alignment with the longitudinal direction.

30. The system for securing a connector port of claim 19, wherein the plug replicator nose has a proximal portion retained by the main shell and a distal portion and wherein the sloped portions of the first and second ramp surfaces are sloped in the dorsal direction from the distal portion to the proximal portion of the plug replicator nose.

31. The system for securing a connector port of claim 19, wherein the plug replicator nose replicates an electronic connector plug in size and shape and further comprising a plurality of electrical contacts retained by the plug replicator nose along the ventral side of the plug replicator nose.

32. The system for securing a connector port of claim 31, wherein the plug replicator nose replicates an RJ-45 connector plug in size and shape.

33. The system for securing a connector port of claim 32, wherein the plurality of electrical contacts retained by the plug replicator nose are configured to provide Power-over-Ethernet (PoE) to the connector port locking apparatus.
